(19) United States
(12) Patent Application Publication
(10) Pub. No.: US 2009/0130345 A1
(43) Pub. Date: May 21, 2009

(54) CONSTRUCTION OF AN ARTIFICIAL AQUATIC LIFE FORM AND ANCHOR

(75) Inventors: Norman Anderson, Brooklyn, NY (US); Jonathan Willinger, Tenafly, NJ (US)

Correspondence Address: KATTEN MUCHIN ROSENMAN LLP, 575 MADISON AVENUE, NEW YORK, NY, 10022-2585, US

(73) Assignee: JW PET COMPANY, INC., Teterboro, NJ (US)

(21) Appl. No.: 11/940,660

(22) Filed: Nov. 15, 2007

(51) Int. Cl. B44C 5/06; E02D 5/80

(52) U.S. Cl. 428/13; 206/423; 52/166

(57) ABSTRACT

An artificial life form construction includes an artificial aquatic life form for display; an anchor for receiving the artificial aquatic life form; and a retainer for aiding in retaining the artificial aquatic life form in the anchor. The artificial aquatic life form may have a stem, which the anchor receives with frictional fit in a support. The stem may include an opening. The retainer includes a plug portion, which is inserted in to the opening and expands a peripheral portion of the stem at the opening to increases frictional resistance with the support to prevent dislocation of the artificial aquatic life form.

### BACKGROUND OF THE INVENTION

1. Field of the Invention

The present invention relates to the construction of an artificial aquatic life form, and, in particular, to a base for an artificial aquatic life form.

2. Description of the Related Art

Aquatic environments, such as aquariums, are typically configured to include a plurality of life. A convenient form is an artificial aquatic life form, such as aquarium plant or aquarium coral, that adds visual appeal to the aquarium.

Typically, artificial aquatic life forms are constructed to include a base having a substantial mass to weight the base and keep the artificial aquatic life form from drifting in the currents of the aquatic environment.

Some bases have a mass of cement or sand encased in plastic. Other bases are stylized and include a mass that has the appearance of a sea floor. However, these weighted bases provide a contrast to the remaining environment of an aquarium bottom that is typically covered with gravel.

U.S. Pat. No. 4,185,743, which is herein incorporated in its entirety by reference for all purposes, suggests the use of an anchor into which an artificial aquatic life form is secured using a bifurcated stem end. The anchor comprises a narrow V-shape that is filled with gravel.

However, with time, the bifurcated stem end becomes worn and dislodges easily. Similarly, the anchor includes storage cells for gravel or sand that limit the size of the plant that can be anchored.

What is desired is an improvement in the construction of an artificial aquatic life form and an anchor therefore.

### SUMMARY OF THE INVENTION

These and other objectives are met by the embodiments of the present invention.

An artificial life form construction includes an artificial aquatic life form for display; an anchor for receiving the artificial aquatic life form; and a retainer for aiding in retaining the artificial aquatic life form in the anchor. The artificial aquatic life form may have a stem, which the anchor receives with frictional fit in a support. The stem may include an opening. The retainer includes a plug portion, which is inserted in to the opening and expands a peripheral portion of the stem at the opening to increases frictional resistance with the support to prevent dislocation of the artificial aquatic life form.

### BRIEF DESCRIPTION OF THE DRAWINGS

FIG. 1 is an exploded elevational view a portion of an artificial aquatic life form and an anchor for the artificial aquatic life form in accordance with one embodiment of the present invention.

FIG. 2 is a perspective view of the anchor of FIG. 1.

FIG. 3 is a top view of the anchor of FIG. 1

FIG. 4 is a front view of the anchor of FIG. 1

FIG. 5 is a cross-sectional view of the artificial aquatic life form construction of FIG. 1.

FIG. 6 is a cross-sectional view of the artificial aquatic life form construction of FIGS. 1 and 5 in an assembled status.

### DETAILED DESCRIPTION OF THE INVENTION

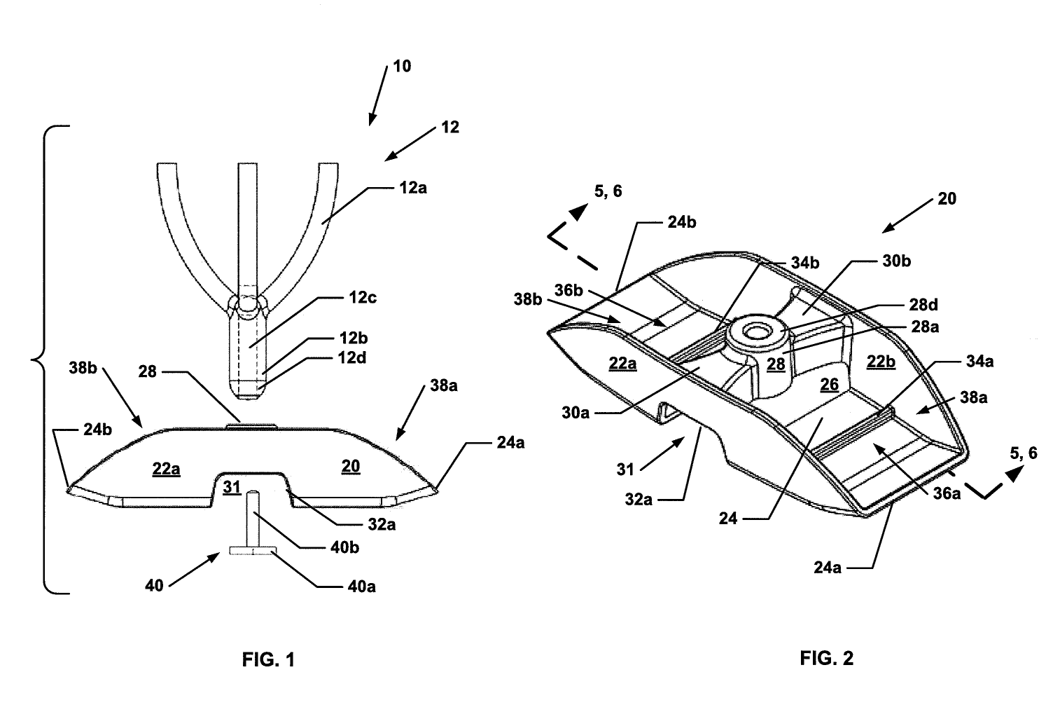

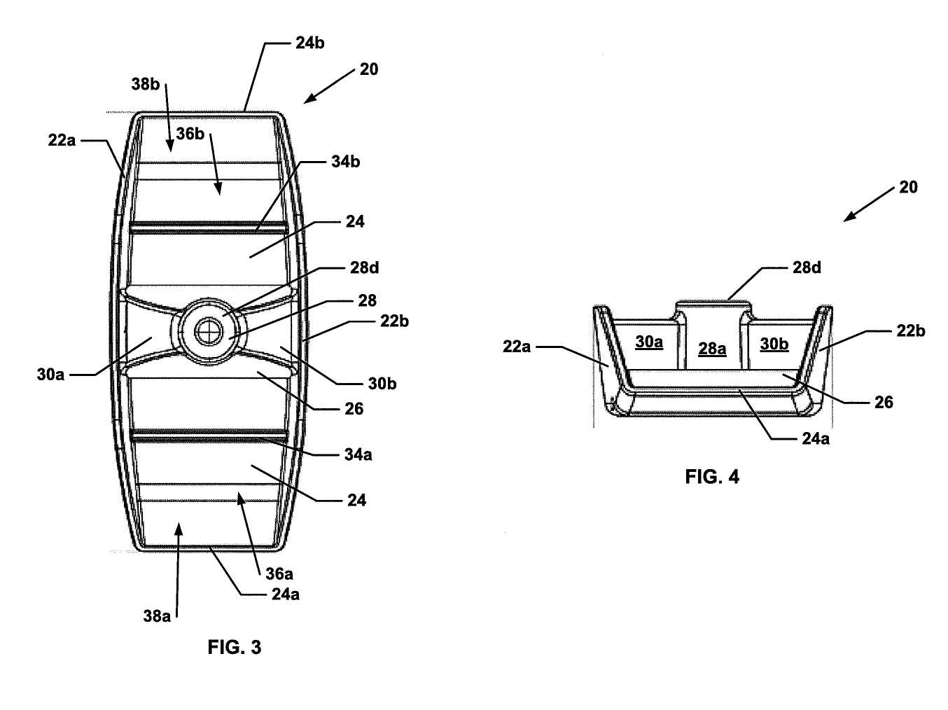

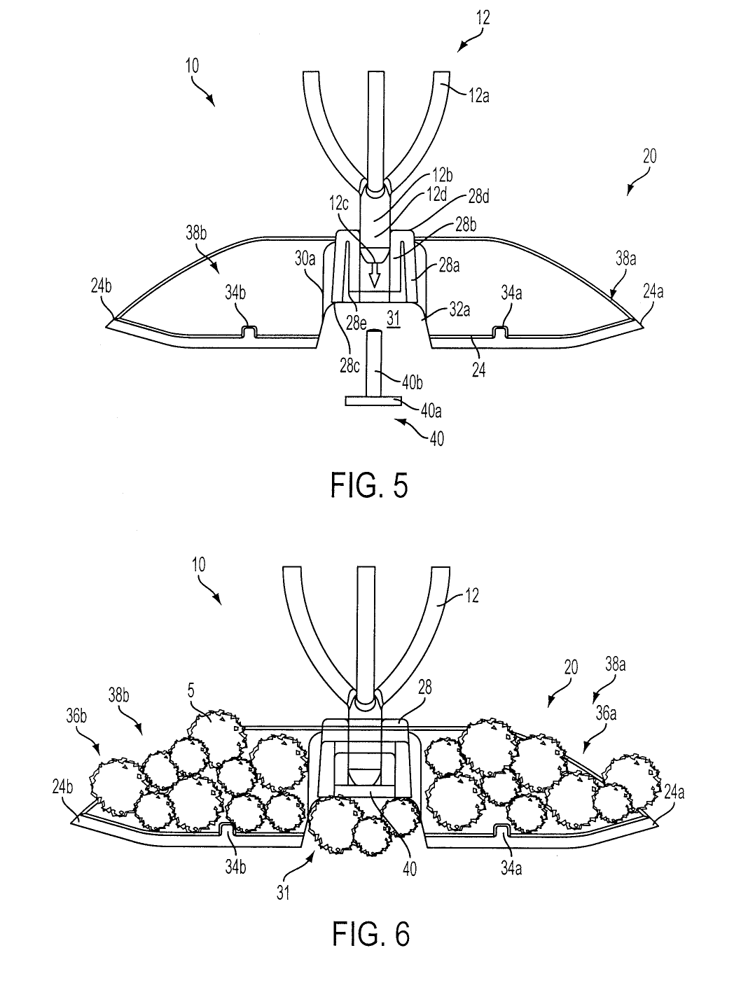

With reference to FIGS. 1-6, an artificial aquatic life form construction 10 includes an artificial aquatic life form 12 for display in an aquarium or the like, an anchor 20 for receiving the artificial aquatic life form, and a retainer 40 for aiding in retaining the artificial aquatic life form in the anchor.

The artificial aquatic life form preferably comprises materials known in the art and may be made, but not necessarily, of plastic or the like. Artificial aquatic life form 12 is formed to support further refinements on arms 12a. A stem 12b is formed at one end of the artificial aquatic life form and includes an opening 12c surrounded by a peripheral portion 12d of the stem. The stem and or the peripheral portion may be tapered to permit easier insertion of the stem into a support 28.

Anchor 20 may be made, but not necessarily, of a durable material, such as plastic and is matched to the artificial aquatic life form such that stem 12b has a frictional fit in support 28. Preferably, the anchor and/or the artificial aquatic life form are made from injection mold material.

The anchor includes a pair of spaced-apart upright wall of 22a, 22b that are connected to each other by a discontinuous floor 24 that includes end portions that are turned upwards at end edges 24a, 24b.

A platform 26 rises from the floor and bridges the upright walls. Support 28 and optional side members 30a and 30b are disposed on the platform. The platform is preferably hollow and may be suitable sized to create a continuous passage 31 between one recess 32a in one wall 22a and a recess in the other wall 22b to permit water flow or permit gravel to reside in the opening to resist sliding of the anchor. The passage is preferably transverse to a longitudinal axis and is located at an underside of the anchor.

Passage 31 also permits a user to correctly manipulate a plug portion of the retainer into the opening 12c of the stem.

Support 28 is preferably configured to be an annular member having an outer surface 28a having an edge 28c and a resilient inner member 28b connected along a crown 28d to each other. Inner member 28b is preferably sized slightly smaller than the diameter of stem 12b to receive stem 12b with frictional resistance to resist unintended disengagement of the artificial aquatic life form from the anchor. To further aid in frictional resistance, the inner member comprises a taper toward its distal end 28e that also permits it to flex.

When the stem is inserted in the support, inner member 28b flexes to accommodate the larger diameter of the stem.

A pair of barriers 34a and 34b are preferably raised from the floor and aid in holding gravel from leaving respective inner spaces 36a, 36b formed in the volume formed in the respective upright walls, floor and end edges, wherein the volume extends to the platform.

The shape of the floor and preferably up-turned end edges in each inner space create respective scoops 38a, 38b that move weighted material, such as gravel 5, into one or both of the inner spaces and aid in fixing the position of the anchor relative to the aquarium.

Retainer 40 includes a base portion 40a and plug portion 40b configured to have a diameter slightly larger than opening 12c. The plug portion is inserted, preferably forced, into opening 12c for a frictional fit to expand the stem of the artificial aquatic life form at peripheral portion 12d. In turn, the stem bears against the wall of the inner member 28b and increases the frictional resistance between the two to resist dislocation of the artificial aquatic life form.

Base portion 40a bears against edge 28c and/or end 28c to aid in resisting the dislocation of the artificial aquatic life form. Preferably, each of edge 28c and end 28e are configured to match the thickness of the base portion 40a to avoid obstructing passage 31.

In use, a user selects an artificial aquatic life form 12 suitable for their aquarium or the like. If necessary, the further refinements, such as branches, flowers or the like, are connect to arms 12a. The artificial aquatic life form that is selected preferably includes a stem 12b that is substantially higher than the anchor.

The user then selects an anchor such that stem 12b has a frictional fit in support 28. In one or more embodiments, the anchor and the artificial aquatic life form provided so that they are coordinated to have sizes that are suited for each other.

The user then inserts stem 12b into support 28 so that the inner member 28b surrounds stem 12b. Inner member 28b, having a smaller diameter than the stem, will flex out to accommodate the stem. The user then inserts the plug portion into opening 12c of the stem expanding the peripheral portion 12d and increasing the frictional fit between the stem and inner member.

The user utilizes edges 24a and 24b, i.e., scoops 38a, 38b, to scoop gravel 5 or the like into inner spaces 36a, 36b to weight the anchor and resist dislocation of the artificial aquatic life form. The anchor may be further positioned by ensuring that gravel is located in the passage.

While the invention has been described in conjunction with specific embodiments, it is to be understood that many alternatives, modifications, and variations will be apparent to those skilled in the art in light of the foregoing description.

What is claimed is:

1. An artificial life form construction comprising:
an artificial aquatic life form for display;
an anchor for receiving the artificial aquatic life form; and
a retainer for aiding in retaining the artificial aquatic life form in the anchor.

2. The artificial aquatic life form construction of claim 1, wherein the artificial aquatic life form comprises a stem, the anchor comprises a support that receives the stem, the stem comprising frictional fit in the support.

3. The artificial aquatic life form construction of claim 2, the stem comprising an opening, the retainer comprising a plug portion, the plug portion being inserted in to the opening, the plug portion expanding a peripheral portion of the stem at the opening to increases frictional resistance with the support to prevent dislocation of the artificial aquatic life form.

4. The artificial aquatic life form construction of claim 1, wherein the anchor comprises raised a platform, the support being disposed in the platform.

5. The artificial aquatic life form construction of claim 1 wherein the anchor comprises an inner spaced defined by a floor, spaced-apart walls upright from the floor, an end edge, the inner space for holding a weighted material.

6. The artificial aquatic life form construction of claim 5 wherein the floor comprises a barrier raised from the floor for aiding in holding the weighted material.

7. The artificial aquatic life form construction of claim 1 wherein the anchor comprises a scoop defined by a floor, spaced-apart walls upright from the floor, an up-turned end edge, the scoop for scooping weighted material into an inner space.

8. The artificial aquatic life form construction of claim 7 wherein the floor comprises a barrier raised from the floor for aiding in holding the weighted material.

9. The artificial aquatic life form construction of claim 1 wherein the anchor comprises a pair of spaced-apart walls upright from a discontinuous floor, the discontinuous floor being bridged by a platform that includes the support.

10. The artificial aquatic life form construction of claim 9, wherein the anchor comprises a recess being provided in each wall and a passage being disposed from one recess to the other recess.

11. An artificial aquatic life form construction comprising:
an artificial aquatic life form for display, the artificial aquatic life form comprising a stem portion:
an anchor receiving the stem portion with frictional fit;
a retainer for aiding in retaining the stem in the anchor by expanding a peripheral portion of the artificial aquatic life form for increasing the frictional fit in the anchor.

12. The artificial aquatic life form construction of claim 11, wherein the anchor comprises a scoop for scooping a weighted material for preventing displacement of the artificial aquatic life form construction relative to its environment.

13. The artificial aquatic life form construction of claim 11, wherein the anchor comprises a transverse passage.

14. An artificial aquatic life form construction comprising:
a display element;
a receiving element for receiving an end of the display element with a frictional fit;
a retaining element being received in an opening in the end of the display element, the retaining element comprising a plug portion expanding a peripheral portion of the end of the display portion for increasing the frictional fit.

15. An artificial aquatic life form construction of claim 14 wherein the receiving element comprises an inner spaced defined by a floor, spaced-apart walls upright from the floor, an end edge, the inner space for holding a weighted material.

16. The artificial aquatic life form construction of claim 15 wherein the floor comprises a barrier raised from the floor for aiding in holding the weighted material.

17. The artificial aquatic life form construction of claim 14 wherein the receiving element comprises a scoop defined by a floor, spaced-apart walls upright from the floor, an up-turned end edge, the scoop for scooping weighted material into an inner space.

18. The artificial aquatic life form construction of claim 17 wherein the floor comprises a barrier raised from the floor for aiding in holding the weighted material.
